(19) United States
(12) Patent Application Publication
(10) Pub. No.: US 2017/0204824 A1
(43) Pub. Date: Jul. 20, 2017

(54) Roller Tappet Device and Method for Producing a Roller Tappet Device

(71) Applicant: CONTINENTAL AUTOMOTIVE GMBH, Hannover (DE)

(72) Inventors: Stefan Roider, Cham (DE); Ludwig Kirschenhofer, Regensburg (DE); Detlef Haupt, Regenstauf / Steinsberg (DE); Christian Kemna, Zeitlarn (DE); Martin Schmidt, Regensburg (DE)

(73) Assignee: CONTINENTAL AUTOMOTIVE GMBH, Hannover (DE)

(21) Appl. No.: 15/479,968

(22) Filed: Apr. 5, 2017

Related U.S. Application Data
(63) Continuation of application No. PCT/EP2015/059891, filed on May 6, 2015.

(30) Foreign Application Priority Data
Oct. 15, 2014 (DE) 10 2014 220 881.5

(51) Int. Cl. F02M 59/10; F04B 9/04

(52) U.S. Cl. CPC F02M 59/102; F04B 9/042

(57) ABSTRACT

A roller tappet device for a pump having a drive mechanism is provided. The roller tappet device includes a tappet having a longitudinal axis and a tappet housing having an internal surface area and a housing bearing. The tappet device includes a bearing shell, a bearing-shell clearance, and a pin on a side of the bearing shell that faces away from the bearing-shell clearance. The pin is received in the housing bearing of the tappet housing. The roller tappet includes a roller that has a rotation axis and is rotatably mounted within the bearing-shell clearance. The bearing shell is fixedly coupled to the tappet housing. The roller is supported on the drive mechanism; and during operation of the pump, the roller transmits a force along the longitudinal axis from the drive mechanism by way of the bearing shell to the tappet.

### CROSS-REFERENCE TO RELATED APPLICATIONS

This application claims the benefit of PCT Application PCT/EP2015/059891, filed May 6, 2015, which claims priority to German Application DE 10 2014 220 881.5, filed Oct. 15, 2014. The disclosures of the above applications are incorporated herein by reference.

### TECHNICAL FIELD

The present disclosure relates to a roller tappet device for a pump, and to a corresponding method for producing the roller tappet device.

### SUMMARY

The disclosure provides a roller tappet device for a pump, which contributes toward a reliable and efficient operation of the pump. Furthermore, the disclosure provides a corresponding method for producing the roller tappet device.

One aspect of the disclosure provides a roller tappet device for a pump. The roller tappet device includes a tappet having a longitudinal axis, a tappet housing having an internal surface area, a bearing shell having an external surface area, and a roller having a rotation axis.

The bearing shell has a bearing-shell clearance in which the roller is rotatably mounted. Furthermore, the bearing shell on a side that faces away from the bearing-shell clearance has a pin that is received in a housing bearing of the tappet housing. The bearing shell by way of an external surface area of the pin, and of an internal surface area of the housing bearing is fixedly coupled to the tappet housing.

The roller is supported on a drive mechanism of the pump. During operation of the pump, the roller is furthermore configured to transmit a force along the longitudinal axis (L) from the drive mechanism by way of the bearing shell to the tappet.

Fixing the bearing shell to the tappet housing contributes toward avoiding tilting of the bearing shell in the tappet housing.

Decoupling of the fixation from a mounting of the roller is enabled by fixing the bearing shell to the tappet housing by means of a fixed coupling by way of the external surface area of the pin and of the internal surface area of the housing bearing. Furthermore, decoupling of the fixation from a guide of the tappet housing along the longitudinal axis is enabled by the fixed coupling by way of the external surface area of the pin and of the internal surface area of the housing bearing. Furthermore, the fixed coupling by way of the external surface area of the pin and of the internal surface area of the housing bearing contributes toward a direct routing of force between the bearing shell and the tappet such that a gearing-free routing of force between the roller and a piston of the pump, which is disposed on a side of the tappet that faces away from the bearing shell, is enabled, for example.

In some examples, the pump is a high-pressure fuel pump, such as, but not limited to a high-pressure diesel pump. The drive unit includes a cam on which the roller is supported, for example. The roller tappet device in an advantageous manner is configured to convert a rotating movement of the cam to a linear movement along the longitudinal axis.

In some implementations, a diameter of the pin is less than 75% of a diameter of the internal surface area of the tappet housing. In some example, the diameter of the pin is less than 35% of the diameter of the internal surface area of the tappet housing.

The bearing shell and the tappet housing have corresponding openings that enable a flow of fluid along the longitudinal axis, for example.

In some implementations, the external surface area of the pin and the internal surface area of the housing bearing are fixedly coupled by means of an interference fit assembly.

The interference fit assembly enables reliable, cost-effective coupling of the bearing shell and the tappet housing. In some examples, the interference fit assembly is an oil interference fit assembly.

In some implementations, that side of the bearing shell that faces away from the bearing-shell clearance has a bearing-shell stop face. Furthermore, that side of the tappet housing that faces the bearing shell has a housing stop face. The bearing-shell stop face and the housing stop face are configured to be mutually parallel.

The mutually parallel stop faces of the bearing-shell and the housing contribute toward a perpendicularity between a rotation axis of the roller and the longitudinal axis. On account thereof, an efficient and reliable operation of the roller tappet device is enabled in an advantageous manner. In some examples, the mutually parallel stop faces are parallel with the rotation axis of the roller.

In some implementations, the internal surface area of the tappet housing is configured to restrict a displacement of the roller in the direction of the rotation axis.

Restricting the displacement of the roller in the direction of the rotation axis contributes toward an efficient and reliable operation of the roller tappet device.

In some examples, the internal surface area of the tappet housing has two planar and mutually diametrical thrust surfaces that are configured to restrict the displacement of the roller in the direction of the rotation axis.

Restricting the displacement of the roller is thus particularly efficiently contributed toward in an advantageous manner. Herein, the thrust surfaces are in particular parallel with the longitudinal axis.

In some implementations, at least one bearing-shell part-region of the external surface area of the bearing shell, and a respective housing part-region of the internal surface area of the tappet housing are configured to be curved in parallel in relation to one another in such a manner that a torque in relation to the longitudinal axis is transmittable from the bearing shell to the tappet housing.

Therefore, this contributes in an advantageous manner toward avoiding torsioning of the bearing shell in relation to the tappet housing. A torsional restriction of the bearing shell of such a type, for example during assembly of the roller tappet device, contributes toward the fixed coupling of the bearing shell to the tappet housing being able to be performed in an aligned manner. By functionally decoupling the torsional restriction by means of the external surface area of the bearing shell from the fixed coupling of the bearing shell by means of the external surface area of the pin, a variable geometry of the internal surface area of the tappet housing is enabled, for example, such that a contribution toward a particularly advantageous restriction of the displacement of the roller in the direction of the rotation axis is made.

In some examples, the external surface area of the bearing shell, in order to restrict torsioning, herein is configured to be rotationally symmetrical to the longitudinal axis.

In some implementations, the at least one bearing-shell part-region and the respective housing part-region are configured to be planar.

Advantageously, this contributes in a particularly cost-effective manner toward avoiding torsioning of the bearing shell. For example, the external surface area of the bearing shell has two diametrically parallel, planar bearing-shell part-regions, and the internal surface area of the tappet housing, in a complementary manner thereto, has at least two diametrically parallel, planar housing part-regions. The at least one bearing-shell part-region and the at least one housing part-region may also be referred to as key surfaces.

Another aspect of the disclosure provides a method for producing a roller tappet device for a pump according to the first aspect, in which a tappet having a longitudinal axis, a tappet housing having an internal surface area, a bearing shell having an external surface area, and a roller having a rotation axis are provided.

The bearing shell has a bearing-shell clearance in which the roller is rotatably mounted. Furthermore, the bearing shell on a side that faces away from the bearing-shell clearance has a pin that is received in a housing bearing of the tappet housing. The bearing shell by way of an external surface area of the pin, and of an internal surface area of the housing bearing is fixedly coupled to the tappet housing by means of an interference fit assembly.

The roller is supported on a drive mechanism of the pump.

In the case in which the roller tappet device has a torsioning restriction of the bearing shell in relation to the tappet housing, for example in that at least one bearing-shell part-region of the external surface area of the bearing shell, and a respective housing part-region of the internal surface area of the tappet housing are configured to be curved in parallel in relation to one another in such a manner that a torque in relation to the longitudinal axis is transmittable from the bearing shell to the tappet housing, a contribution is made toward a press-fit between the bearing shell and the tappet housing being able to be performed in an aligned manner. For example, the bearing shell by means of the torsional restriction is initially aligned in relation to the tappet housing and is subsequently press-fitted.

The details of one or more implementations of the disclosure are set forth in the accompanying drawings and the description below. Other aspects, features, and advantages will be apparent from the description and drawings, and from the claims.

### DESCRIPTION OF DRAWINGS

Implementations of the disclosure are explained hereunder by means of the schematic drawings in which:

FIG. 1 shows a longitudinal section of a roller tappet device;

FIG. 2 shows a perspective illustration of a bearing shell of the roller tappet device according to FIG. 1;

FIG. 3 shows a perspective illustration of a tappet housing of the roller tappet device according to FIG. 1; and

FIG. 4 shows a perspective illustration of the roller tappet device according to FIG. 1.

In the figures, elements of identical construction or function are provided with the same reference signs throughout.

### DETAILED DESCRIPTION

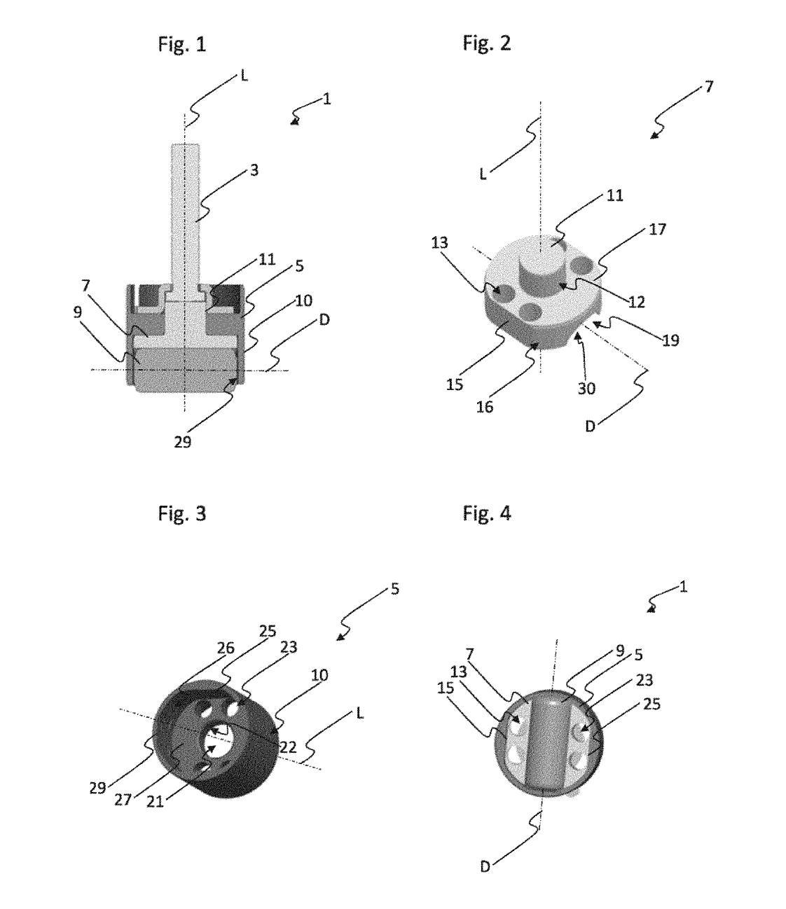

A roller tappet device 1 for a pump, such as, for a high-pressure fuel pump, includes a tappet 3 having a longitudinal axis L (FIG. 1). The roller tappet device 1 furthermore has a tappet housing 5, a bearing shell 7, and a roller 9, which are disposed so as to be axially symmetrical to the longitudinal axis L, for example.

In some examples, the pump is a high-pressure diesel pump. In other examples, the pump is a high-pressure gasoline pump.

The pump has a drive mechanism, a pump housing, and a piston (not illustrated in more detail), for example. The piston of the pump herein is coupled to the tappet 3, for example.

In some examples, the drive mechanism includes a shaft having a cam on which the roller is supported. During operation of the pump, a rotating movement of the cam is converted to a linear movement of the roller tappet device 1 along the longitudinal axis L. In some examples, the roller 9 is mounted so as to be rotatable about a rotation axis D, thus contributing toward low-friction rolling of the cam.

Furthermore, in some examples, the tappet housing 5 by way of the external surface area 10 is guided in the pump housing, thus contributing during operation of the pump toward a precise linear movement of the roller tappet device along the longitudinal axis L. For example, during operation of the pump a transmission of the force of the cam is performed by way of the roller tappet device 1 to the piston.

In some examples, the bearing shell 7 has a pin 11 having an external surface area 12. The tappet 3 sits on the pin 11, for example, such that a substantially gearing-free routing of force from the bearing shell 7 to the piston is enabled.

Furthermore, the bearing shell 7 may have at least one bearing-shell opening 13 which enables a flow of fluid along the longitudinal axis L (FIG. 2). The bearing shell 7 on the external surface area 16 may have two mutually opposite bearing-shell part-regions 15, a bearing-shell stop face 17, and facing away therefrom, a bearing-shell clearance 19 that is configured for receiving the roller 9.

In some examples, the tappet housing 5 is configured for receiving the bearing shell 7. In this example, the tappet housing 5 has a housing bearing 21 having an internal surface area 22 (FIG. 3) into which the pin 11 is introduced. The tappet housing 5 furthermore may have at least one housing opening 23 which corresponds to the respective bearing-shell opening 13.

Furthermore, the tappet housing 5 on the internal surface area 26 thereof has two mutually opposite housing part-regions 25 which correspond to the bearing-shell part-regions 15 of the bearing shell 7. In addition, the tappet housing 5 has a housing stop face 27 which corresponds to the bearing-shell stop face 17 of the bearing shell 7.

The external surface area 16 of the bearing shell 7, and the internal surface area 26 of the tappet housing 5, by means of the bearing-shell part-regions 15 or of the housing part-regions 25, respectively, are configured to be in particular rotationally symmetrical in relation to the longitudinal axis L. As such, torsioning of the bearing shell 7 about the longitudinal axis L in the tappet housing 5 is restricted in an advantageous manner. Furthermore, this enables aligning of the bearing shell 7 in relation to the tappet housing 5 when assembling the roller tappet device 1.

Herein, the bearing-shell part-regions 15 and the housing part-regions 25 are configured to be in particular planar and mutually parallel. The bearing-shell part-regions 15 and the housing part-regions 25 may also be referred to as key-surface-type geometries.

The housing stop face 27 restricts a displacement of the bearing shell 7 in relation to the tappet housing 5 in the direction of the tappet 3 along the longitudinal axis L. Therefore, the housing stop face 27 bears on the bearing-shell stop face 17, for example. In some implementations, the bearing-shell stop face 17 and the housing stop face 27 are configured to be mutually parallel, for example, to be parallel with the rotation axis D of the roller 9. A precise alignment of the bearing shell 7 with the roller 9 in relation to the longitudinal axis L is thus enabled in an advantageous manner. In some examples, this thus contributes to a perpendicularity of the rotation axis D in relation to the longitudinal axis L.

In some examples, after aligning of the bearing shell 7 in relation to the tappet housing 5, fixing the bearing shell 7 in relation to the tappet housing 5 is performed during assembly of the roller tappet device 1, such that a movement of the bearing shell 7 in relation to the tappet housing 5 in the direction of the rotation axis D, or perpendicularly to the rotation axis D and to the longitudinal axis L, is substantially avoided.

In some implementations, the external surface area 12 of the pin 11 is fixedly coupled to the internal surface area 22 of the housing bearing 21. The bearing shell 7, for example by way of an interference fit assembly on the external surface area 12 of the pin 11, is fixed to the tappet housing 5 at the internal surface area 22 of the housing bearing 21, where a diameter of the interference fit assembly is less than 75% of a diameter of the external surface area 16 of the bearing shell 7. In some examples, the diameter of the interference fit assembly is less than 35% of the diameter of the external surface area 16 of the bearing shell 7.

In an advantageous manner, the surfaces of the bearing shell 7 or of the tappet housing 5, respectively, for aligning the bearing shell 7 in relation to the tappet housing 5 are functionally separate from surfaces for fixing the bearing shell 7 in relation to the tappet housing 5. This enables a variable design of the internal surface area 26 of the tappet housing 5, for example in terms of mounting the roller 9.

During operation of the pump, a force in the direction of the rotation axis D acts on the roller 9, for example. In this context, the internal surface area 26 of the tappet housing 5 is configured to restrict a displacement of the roller 9 in the direction of the rotation axis D. As such, the internal surface area 26 of the tappet housing 5 has mutually opposite thrust surfaces 29 (cf. also FIG. 1).

By functionally separating respective surfaces for aligning and fixing the bearing shell 7 in relation to the tappet housing 5, the thrust surfaces 29 may each be configured as a planar contact surface in relation to the roller 9, for example.

FIG. 4 shows a perspective illustration of the roller tappet device 1 according to FIG. 1, along the longitudinal axis L. In an advantageous manner, a roller tappet device 1 of this type enables decoupling of the interference fit assembly from the external surface area 10 of the tappet housing 5 for guiding in the pump housing. Moreover, decoupling of the interference fit assembly from a bearing surface area 30 (cf. FIG. 2) of the bearing-shell clearance 19 for radial guiding of the roller is enabled. Furthermore, a roller tappet device 1 of this type contributes toward a direct routing of force between the piston and the bearing shell 7.

A number of implementations have been described. Nevertheless, it will be understood that various modifications may be made without departing from the spirit and scope of the disclosure. Accordingly, other implementations are within the scope of the following claims.

What is claimed is:

1. A roller tappet device for a pump having a drive mechanism, the roller tappet device comprising:
a tappet having a longitudinal axis;
a tappet housing having an internal surface area and a housing bearing;
a bearing shell includes an external surface area, a bearing-shell clearance, and a pin on a side of the bearing shell that faces away from the bearing-shell clearance, the pin is received in the housing bearing of the tappet housing; and
a roller having a rotation axis, the roller is rotatably mounted within the bearing-shell clearance
wherein the bearing shell by way of an external surface area of the pin, and of an internal surface area of the housing bearing is fixedly coupled to the tappet housing; and
wherein the roller is supported on the drive mechanism of the pump and during operation of the pump is configured to transmit a force along the longitudinal axis from the drive mechanism by way of the bearing shell to the tappet.

2. The roller tappet device of claim 1, wherein the external surface area of the pin and the internal surface area of the housing bearing are fixedly coupled by means of an interference fit assembly.

3. The roller tappet device of claim 1, wherein that side of the bearing shell that faces away from the bearing-shell clearance has a bearing-shell stop face, and that side of the tappet housing that faces the bearing shell has a housing stop face, wherein the bearing-shell stop face and the housing stop face are configured to be mutually parallel.

4. The roller tappet device of claim 1, wherein the internal surface area of the tappet housing is configured to restrict a displacement of the roller in the direction of the rotation axis.

5. The roller tappet device of claim 4, wherein the internal surface area of the tappet housing has two planar and mutually diametrical thrust surfaces which are configured to restrict the displacement of the roller in the direction of the rotation axis.

6. The roller tappet device of claim 1, wherein at least one bearing-shell part-region of the external surface area of the bearing shell, and a respective housing part-region of the internal surface area of the tappet housing are configured to be curved in parallel in relation to one another in such a manner that a torque in relation to the longitudinal axis is transmittable from the bearing shell to the tappet housing.

7. The roller tappet device of claim 6, wherein the at least one bearing-shell part-region and the respective housing part-region are configured to be planar.

8. A method for producing a roller tappet device for a pump having a drive mechanism, the method comprising:
providing a tappet having a longitudinal axis;
providing a tappet housing having an internal surface area and a housing bearing;
providing a bearing shell including an external surface area, a bearing-shell clearance, and a pin on a side of the bearing shell that faces away from the bearing-shell clearance;
receiving the pin in the housing bearing of the tappet housing;
providing a roller having a rotation axis;
rotatably mounting the roller within the bearing-shell clearance;
fixedly coupling by means of an interference fit assembly the bearing shell by way of an external surface area of the pin, and of an internal surface area of the housing bearing; and
supporting the roller on a drive mechanism of the pump.
